(19) United States
(12) Patent Application Publication
(10) Pub. No.: US 2005/0223582 A1
(43) Pub. Date: Oct. 13, 2005

(54) Multiple reel conversion tape measure

(76) Inventor: Corey Baugh, Columbus, IN (US)

Correspondence Address: Randal D. Homburg, P.O. Box 10470, Midwest City, OK, 73140-1470, US

(21) Appl. No.: 11/101,067

(22) Filed: Apr. 7, 2005

Related U.S. Application Data
(60) Provisional application No. 60/561,466, filed on Apr. 12, 2004.

(51) Int. Cl. G01B 3/10

(52) U.S. Cl. 33/764

(57) ABSTRACT

A compact tape measure device having a plurality of independent reels supplied with different conversion scales for architects and engineers allows an architect or engineer to convert linear measurement scales on drawings and blueprints, the device providing three or more reels of incremental measured tape having printed scales on an upper surface and lower surface of each tape, allowing for at least twelve different measured scales provided to either convert feet to inches of differing converted scales or metric to U.S. measurement scale.

### CROSS REFERENCE TO RELATED APPLICATIONS

Applicant claims the benefit of Provisional Patent Application No. 60/561,466 filed Apr. 12, 2004.

### I. BACKGROUND OF THE INVENTION

1. Field of Invention

A compact tape measure device having a plurality of independent reels supplied with different conversion scales for architects and engineers allows an architect or engineer to convert linear measurement scales on drawings and blueprints, the device providing three or more reels of incremental measured tape having printed scales on an upper surface and lower surface of each tape, allowing for at least twelve different measured scales provided to either convert feet to inches of differing converted scales or metric to U.S. measurement scale.

2. Description of Prior Art

The following United States patents were discovered and are disclosed within this application for utility patent. All relate to tape measuring devices with multiple measuring margins or reeled tapes.

Dual tape measuring devices are disclosed in U.S. Pat. Nos. 4,506,446 to Mitchell, 2,240,753 to Bouchard and 3,885,314 to Banas, Sr. All three of these tape measuring devices have opposing measuring tapes which allow for the measurement of two different locations with two tapes with independent markings on the tapes.

Tape measuring devices to measure anatomical areas, most dealing with breast size or brassier sizes are disclosed in U.S. Pat. Nos. 6,276,069 to Chadwick, 5,414,943 to Vogt and 5,619,804 to Vogt, with one tape measuring girth and the other tape measuring cup size, or having two independent scales for measuring for the appropriately sized undergarment support.

U.S. Pat. No. 6,393,710 to Hastings combines a square angle measuring device with a retractable steel tape, which would appear to be an aggregate invention, but was apparently allowed. In U.S. Pat. No. D497,317 to Lee, one of several examples of a design patent of a tape measuring encasement is disclosed. Numerous other design patents for tape measuring devices were also explored, with none bearing common aesthetic embodiment of the present encasement of the present tape measuring device.

### II. SUMMARY OF THE INVENTION

In the architect and engineering industry, office work often involves drafting or interpretation of linear scaled blueprints and drawings which must be to precision scale to insure accuracy of construction and fulfillment of safety concerns. The office usually has plenty of work space, and an architect or engineer generally has all the templates, rulers, and other drafting tools necessary to perform the office tasks. However, the job site is a different story.

In the field, where the actual construction is taking place, the engineer doing the building from the drafted plans does not have all the tools necessary to interpret the drawings and make on site determinations of dimensions for the actual construction, unless the person reading the drawings has several different rulers with conversion scales. This would require the engineer to carry around an assortment of rulers wherever he goes, especially since a construction site generally has several copies of the blueprints and drawings at different locations the construction site, the engineer having to attend to several different locations during his supervision of the construction. If a conventional, single reeled tape measure were employed, having but one upper surface and one lower surface with left and right margins, only four potential scales could be applied to that device. To have twelve scales, or all the essential scales commonly required for multiple blueprints with multiple scaled drawings, one would need three tape measuring devices to have twelve scales, and one would be required to choose the one measuring device appropriate for the scaled interpretation task.

The present invention is a small, compact device which may be carried in one's pocket which has several different measured conversion scales which can be used on the job site to be used with blueprints and construction drawings without having to transport several rulers, including the twelve basic conversion scales most commonly used in the art of architectural conversion. At least three different tape reels are contained within an outer shell, each tape reel being retractable within the outer wheel, each tape having two measured scales on an upper surface and two measured scales on a lower surface, a three reel dispenser having a total of twelve different measured conversion scales. Therefore, having three reeled tapes would not be a mere duplication of a single component, but each tape would have a unique use in that each tape bears a unique and distinct conversion scale, thus providing the three tapes an actual novel utility purpose, not merely a duplicate component, as might be an objection lodged as an argument against novelty or by raising a rejection to obviousness. The device may contain more than three reels, but should not have so many reels that it cannot be transported in a pocket or a small case.

The primary objective of the device is therefore to provide a scaled measuring device having at least three independent retractable tape reels within a singular outer shell having a plurality of scaled measured conversion increments imprinted upon an upper and lower surface of each tape contained upon each tape reel, including at least, twelve basic conversion scales commonly used in architectural drawings.

### III. DESCRIPTION OF THE DRAWINGS

The following drawings are submitted with this utility patent application.

FIG. 1 perspective view of the tape measure.

FIG. 2 a front view of the tape measure.

FIG. 3 is a side view of the tape measure along perspective lines 3/3 of FIG. 2.

FIG. 4 is a cross section view of the tape measure along section lines 4/4 of FIG. 3.

FIG. 5 is a similar view as FIG. 2 with the three retractable reeled tapes extended.

FIG. 6 is an isolated close up view of a tape reel with the retractable reeled tape wound upon a retractable reel.

### IV. DESCRIPTION OF THE PREFERRED EMBODIMENT

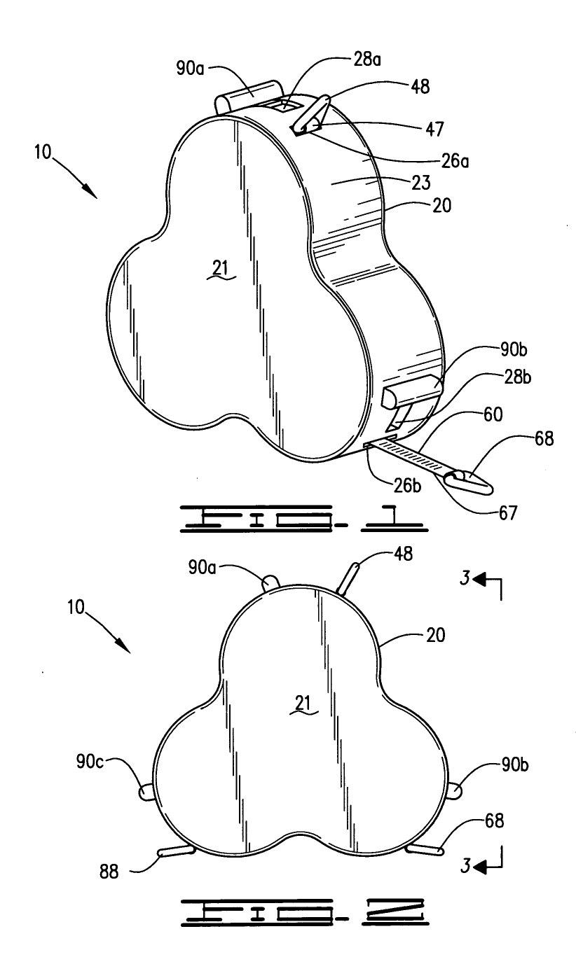

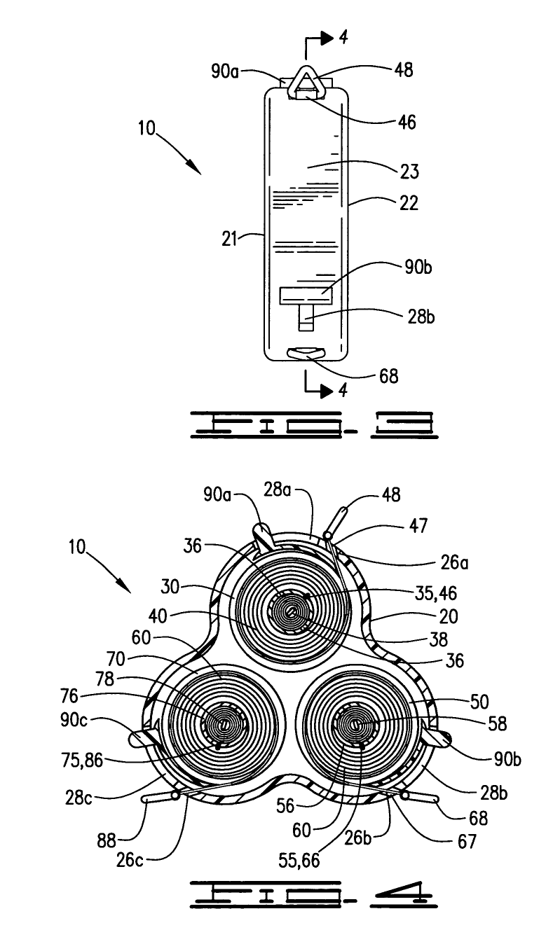

A multiple reeled conversion retractable tape measuring device 10, shown in FIGS. 1-6 of the drawings provides the device 10 for use in conversion of scaled drawings or blueprints for use in engineering, architecture and metric diagram scale conversions, the device 10 comprising a tape encasement 20 defining a front panel 21, a rear panel 22 and a perimeter panel 23 defining an inner cavity 25 within which are independently suspended at least a first retractable reel 30, a second retractable reel 50 and a third retractable reel 70, each reel upon which are independently and respectively wound a first retractable reeled tape 40, a second retractable reeled tape 60 and a third retractable reeled tape 80, each retractable reeled tape 40, 60, 80 having an upper surface 41, 61, 81 and a lower surface 42, 62, 82 with a right margin 43, 63, 83 and a left margin 44, 64, 84, each margin having a conversion scale imprinted upon the upper surface 41, 61, 81 and lower surface 42, 62, 82 at each margin 43, 44, 63, 64, 83, 84. Each retractable reeled tape 40, 60, 80 is directed through a respective first perimeter opening 26a, a second perimeter opening 26b and a third perimeter opening 26c in the perimeter panel 23, allowing each retractable reeled tape 40, 60, 80 to be extended independently from the tape encasement 20 for use to convert measured and scaled drawings, a user selecting the appropriate retractable reeled tape to be used for the selected conversion task. Each retractable reel 30, 50, 70 contains a respective retracting means 38, 58, 78 applying a rotational force independently to each retractable reel 30, 50, 70 to wind the corresponding retractable reeled tape 40, 60,80 upon the retractable reel 30, 50, 70, each retractable reeled tape 40, 60, 80 having a first end 46, 66, 86 attached to the respective retractable reel 30, 50, 70 and a second end 47, 67, 87 to which is attached a tape stop 48, 68, 88, preventing each second end 47, 67, 87 from entering into the respective perimeter opening 26a, 26b, 26c.

The conversion scales which are imprinted on the retractable reeled tapes should include the conversion scales, numbering at least twelve, as follows:

| | | |
|---|---|---|
| ¾ inch = 1 foot | ½ inch = 1 foot | 1 inch = 1 foot |
| ⅜ inch= 1 foot | ¼ inch = 1 foot | 1 inch = 1 inch |
| 3/16 inch = 1 foot | ⅛ inch = 1 foot | 3 inches = 1 foot |
| 3/32 inch = 1 foot | 1/16 inch = 1 foot | 1½ inch = 1 foot |

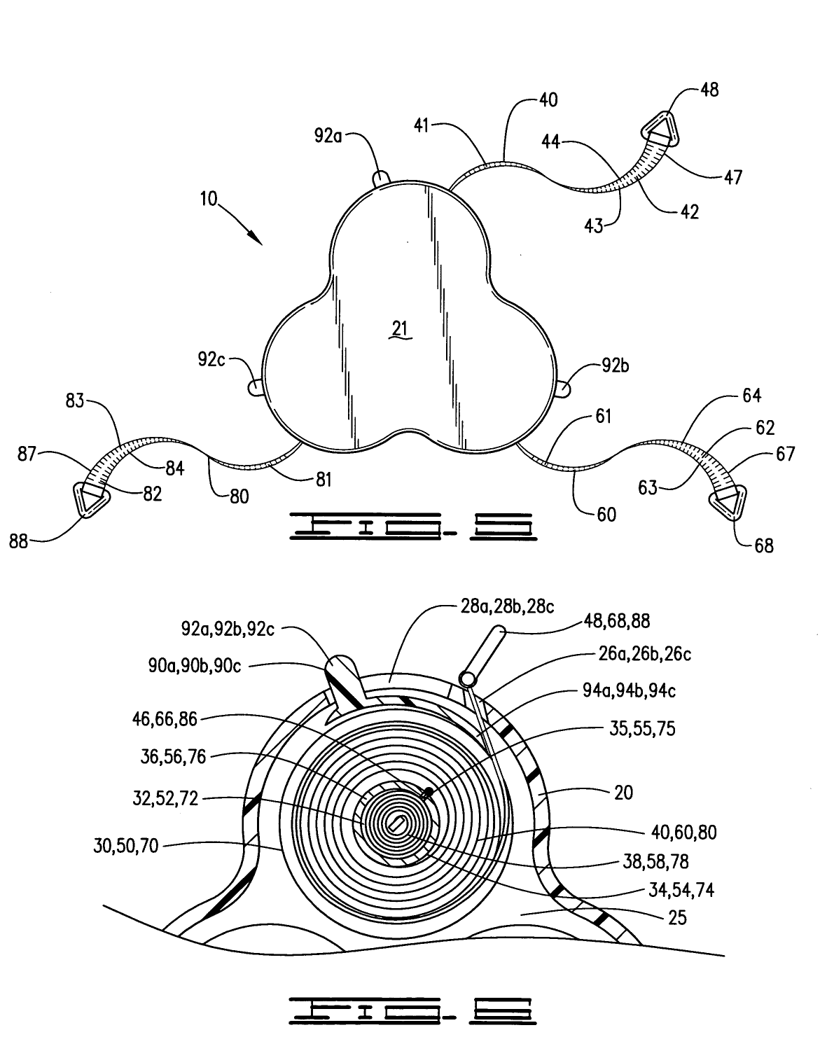

As the first, second and third reeled tapes 40, 60, 80 each have two margins on two surfaces, there would be provided twelve margins in total, each conversion scale would be applied to a single margin on a single surface, as indicated in FIG. 5.

Each retractable reel 30, 50, 70, as indicated in FIGS. 4 and 6, further comprises an inner margin 32, 52, 72 by which the retractable reel 30, 50, 70 is suspended within the tape encasement between the front panel 21 and rear panel 22 by a central spindle 36, 56, 76. Each retractable reel also includes an outer tape surface 34, 54, 64 with an attachment groove 35, 55, 75 within which is affixed the first end 46, 66, 86 of each retractable reeled tape 40, 60, 80. Each retracting means 38, 58, 78 is located within said central spindle 36, 56, 76, as indicated in FIGS. 4 and 6, with the retracting means 38, 58, 78 providing sufficient retractable rotational force to completely wind the retractable reeled tape 40, 60, 80 around the outer tape surface 34, 54, 74 of each retractable reel 30, 50, 70 and retain the second end 47, 67, 87 of the retractable reeled tape 40, 60, 80 against the perimeter panel 23 at the respective perimeter opening 26a, 26b, 26c.

The device 10 may also contain a first tape brake 90a, second tape brake 90b and third tape break 90c contained within the tape encasement 20 near each respective perimeter opening 26a, 26b, 26c which may be applied to retain the respective retractable reeled tape 40, 60, 80 at a chosen length without being retracted back into the tape encasement 20 during use, as indicated in FIGS. 1-6. Each tape brake 90a, 90b, 90c would be slideably engaged with a perimeter panel groove 28a, 28b, 28c, each tape brake 90a, 90b, 90c having an outer thumb protrusion 92a, 92b, 92c, and a locking end 94a, 94b, 94c which applies pressure to the respective retractable reeled tape 40, 60, 80, preventing the retractable reeled tape from being drawn within the tape encasement 20 in a locked position while allowing the retractable reeled tape to be retracted in an unlocked position.

The overall size of the device 10 would be preferably less than four inches in order to be transferred within a person's pants pocket or small case attached to a belt (not shown). The overall shape of the device 10 would preferably be similar to a three-leafed clover, but a triangular shape is also acceptable for a three reeled tape embodiment as shown in the drawings. Although the drawings depict a three reeled embodiment, the device 10 is contemplated to have more than three reels with tape, which would allow for up to four more conversion scales for each tape added, provided the device 10 does not become so large as to lose the ability to transport the device 10 in a compact manner. Additionally, the disclosed scales above pertain generally to architectural scales, but engineering conversion scales or metric conversions scales are also contemplated as useful scales to provide on a measured retractable tape surface.

While the invention has been particularly shown and described with reference to a preferred embodiment thereof, it will be understood by those skilled in the art that changes in form and detail may be made therein without departing from the spirit and scope of the invention.

1. A compact and portable multiple reeled conversion retractable tape measuring device to convert scaled drawings or blueprints in engineering and architecture, the device comprising:
a tape encasement providing a front panel, a rear panel and a perimeter panel defining an inner cavity;
a first retractable reel, a second retractable reel and a third retractable reel independently suspended within said inner cavity;
a first retractable reeled tape, a second retractable reeled tape and a third retractable reeled tape independently wound upon each respective retractable reel, each retractable reeled tape having an upper surface and a lower surface with a right margin and a left margin, each margin having a different conversion scale imprinted upon the upper surface a lower surface.

2. The device, as disclosed in claim 1, wherein each said retractable reeled tape further comprises:
a first end attached to the respective retractable reel and a second end to which is attached a tape stop, each said second end directed through a respective first perimeter opening, a second perimeter opening and a third perimeter opening in said perimeter panel, allowing each said retractable reeled tape to be extended independently from said tape encasement to be used to convert measured and scaled drawings, with each said second end having attached a tape stop preventing each said second end from entering into said respective perimeter opening; and
a respective retracting means applying a rotational force to each said retractable reel to wind said retractable reeled tape upon said retractable reel.

3. The device, as disclosed in claim 1, wherein each said retractable reel further comprises:
an inner margin within which said retractable reel is suspended within said tape encasement between said front panel and said rear panel by a central spindle within which a retracting means is located, said retracting means providing sufficient retractable rotational force to completely wind said retractable reeled tape around said retractable reel and retain a second end of said retractable reeled tape having an applied tape stop against said perimeter panel at a respective perimeter opening; and
an outer tape surface with an attachment groove within which is affixed said first end of said retractable reeled tape.

4. The device, as disclosed in claim 1, further comprising:
a first tape brake, second tape brake and third tape break contained within said inner cavity of said tape encasement, each said tape brake slideably engaged within a respective perimeter panel groove defined within a respective first perimeter opening, a second perimeter opening and a third perimeter opening, each said tape brake retaining each said respective retractable reeled tape at a chosen length without being retracted back into the encasement during use, each tape brake further having an outer thumb protrusion and a locking end, said locking end applied to said respective retractable reeled tape preventing said retractable reeled tape from being drawn within said tape encasement in a locked position, while allowing said retractable reeled tape to be retracted in an unlocked position when said locking end is not applied to said retractable reeled tape.

5. A compact and portable multiple reeled conversion retractable tape measuring device to convert scaled drawings or blueprints in engineering and architecture, the device comprising:
a tape encasement providing a front panel, a rear panel and a perimeter panel defining an inner cavity;
a first retractable reel, a second retractable reel and a third retractable reel independently suspended within said inner cavity, each said retractable reel further comprising an inner margin within which said retractable reel is suspended within the tape encasement between said front panel and said rear panel by a central spindle within which a retracting means is located; and
a first retractable reeled tape, a second retractable reeled tape and a third retractable reeled tape independently wound upon each respective retractable reel, each retractable reeled tape having an upper surface and a lower surface with a right margin and a left margin, each margin having a different conversion scale imprinted upon each said right and left margin of each said upper and lower surface, each said retractable reeled tape further comprising a first end attached to the respective retractable reel and a second end to which is attached a tape stop, each said second end directed through a respective first perimeter opening, a second perimeter opening and a third perimeter opening in said perimeter panel, allowing each said retractable reeled tape to be extended independently from said tape encasement to be used to convert measured and scaled drawings, with said second end having attached a tape stop preventing each said second end from entering into said respective perimeter opening, wherein said retracting means applies a rotational force to each said retractable reel to wind said retractable reeled tape upon said retractable reel.

6. The device, as disclosed in claim 5, further comprising:
a first tape brake, second tape brake and third tape break contained within said inner cavity of said tape encasement, each said tape brake slideably engaged within a respective perimeter panel groove defined within said respective first perimeter opening, a second perimeter opening and a third perimeter opening, each said tape brake retaining each said respective retractable reeled tape at a chosen length without being retracted back into the encasement during use, each said tape brake further having an outer thumb protrusion and a locking end, said locking end applied to said respective retractable reeled tape preventing said retractable reeled tape from being drawn within said tape encasement in a locked position, while allowing said retractable reeled tape to be retracted in an unlocked position when said locking end is not applied to said retractable reeled tape.
